(19) United States
(12) Patent Application Publication
(10) Pub. No.: US 2023/0162213 A1
(43) Pub. Date: May 25, 2023

(54) CUTTING MACHINE SUPPLYING AND MARKETING SYSTEM AND METHOD THEREOF

(71) Applicant: COSEN MECHATRONICS CO., LTD., Hsinchu City (TW)

(72) Inventors: MU-SHUI HUANG, Hsinchu City (TW); YING-FAN WU, Hsinchu City (TW)

(21) Appl. No.: 18/098,924

(22) Filed: Jan. 19, 2023

Related U.S. Application Data
(63) Continuation-in-part of application No. 16/722,797, filed on Dec. 20, 2019, now abandoned.

(30) Foreign Application Priority Data
Dec. 24, 2018 (TW) 107146808

(51) Int. Cl. G06Q 30/0202; G06Q 10/087; G05B 13/02

(52) U.S. Cl. CPC G06Q 30/0202; G06Q 10/087; G05B 13/027

(57) ABSTRACT

A cutting machine supplying and marketing system is provided, which includes a plurality of sensors, a cloud analysis device, a cloud data ledger module and a cloud supplying module. The sensors are connected to a plurality of components of a target cutting machine implementing a cutting operation and each sensor provides the operation data of one of the components. The cloud analysis device analyzes the operation data of the components to generate analysis results and generates the healthy statuses of the components according to the analysis results. The cloud data ledger module records the healthy statuses of the components. The cloud supplying module transmits a component purchase reminder message to a user device according to the healthy statuses of the components for the user device to determine whether an order has to be made.

### CROSS REFERENCE TO RELATED APPLICATION

All related applications are incorporated by reference. The present invention is a continuation in part (CIP) to a U.S. patent application with application Ser. No. 16/722,797 entitled “Cutting machine supplying & marketing DLT-based system and method thereof” filed on Dec. 20, 2019, while the U.S. patent application with application Ser. No. 16/722,797 is based on and claims the priority from Taiwan Application with application serial number 107146808, filed on Dec. 24, 2018, and the disclosure of both is hereby incorporated by reference herein in its entirety.

### TECHNICAL FIELD

The technical field relates to a cutting machine supplying and marketing system, in particular to a cutting machine supplying and marketing system. The technical field further relates to the method of the system.

### BACKGROUND

Cutting machines (e.g. bandsaw machines, lathes, milling machines) are frequently-used industrial machines. Currently, a cutting machine supplier usually has a marketing system for marketing the cutting machines manufactured by the supplier and managing the inventory. However, the currently available marketing systems still have a lot of shortcomings needed to be improved.

For example, the currently available marketing systems can provide only the common marketing management and inventory management functions, but cannot actively promote the products. Thus, the currently available marketing systems cannot effectively increase the sales volume of the cutting machines.

Besides, the currently available marketing systems can provide only the common marketing management and inventory management functions, but cannot acquire the operational data of the cutting machines from the customers. Therefore, the suppliers cannot understand the actual performances of the cutting machines and the components thereof.

In the prior art, what is usually measured by the sensors installed on the machine is the operating state of each workpiece when the machine is processing. Furthermore, processing machines of different brands and models have different ranges of processing conditions. Therefore, various machines of different brands have their own data range of processing conditions. Furthermore, although the data generated by different machines used by different users can be used as an important source of big data analysis; however, the correctness, availability and completeness provided by users are insufficient, and as a result, a lot of time is required to spend on data analysis, data mining or data-debug.

Moreover, the known bonus-points feedback mechanism cannot be set in accordance with the real performance of the sawing equipment and its components, the inventory of the sawing equipment and its components, and the demand of users, resulting in that the bonus-points feedback mechanism is useless and cannot bring benefits to both users and manufacturers.

Moreover, the currently available marketing systems can record only the inventory of the cutting machines and the components thereof, but cannot obtain the demand of the customers, so the inventory of the cutting machines tends to be insufficient.

Accordingly, it has become an important issue to provide a cutting machine marketing system in order to improve the above problems of the currently available marketing systems.

### SUMMARY

An embodiment of the disclosure relates to a cutting machine supplying and marketing system, which includes a target cutting machine data input module, a cloud data ledger module and a cloud supplying module. The target cutting machine data input module receives the basic data of the components, the workpieces and the operational status of a target cutting machine. The cloud data ledger module records the basic data. The cloud supplying module compares the basic data with an estimated component mechanical consumption data to generate a comparison result; when the comparison result is less than a threshold, the cloud supplying module transmits a component purchase reminder message to a user device for the user device to determine whether an order has to be made. The cloud supplying module receives an order message transmitted from the user device in order to generate a transaction record. The cloud supplying module further includes a cloud data evaluation module, the cloud data evaluation module is used to evaluate at least one of correctness, completeness, availability of the basic data and whether a connection ratio between the target cutting machine data input module and the cloud data ledger module is normal, and thereby bonus points corresponding to the user device are calculated. The cloud supplying module further includes a query module and a comparison module. The query module is used for querying a model, components of the target cutting machine and the bonus points corresponding to the user device that are related to the order message. The comparison module, for receiving the order message, and confirming whether information stored in a component purchase reminder message matches that in the order message.

An embodiment of the disclosure relates to a cutting machine supplying and marketing system, which further includes an inventory data ledger module for storing a record of deduction of bonus points, the record of deduction of bonus points is corresponding to the component purchase reminder message; wherein when the information in the component purchase reminder message matches that in the order message, the inventory data ledger module is used to store a redeemed bonus-points record sent by the comparison module and the bonus credit record corresponds to the record of deduction of bonus points; and when the information in the component purchase reminder message does not match that in the order message, the inventory data ledger module receives a canceling message of redeeming bonus points sent by the comparison module, and the record of the deduction of bonus points in the inventory data ledger module is deleted according to the canceling message of redeeming bonus points; wherein the information includes the model of the target cutting machine, consumption components of the target cutting machine, and the user device.

An embodiment of the disclosure relates to a cutting machine supplying and marketing system, wherein the cloud data evaluation module makes comparisons according to a component parameter range, a workpiece parameter range and an operational-status parameter range of the target cutting machine that are respectively corresponding to the basic data of components, workpieces and the operational status of the target cutting machine in order to evaluate the correctness of the basic data, and if the basic data of components, workpieces and the operational status of the target cutting machine do not fall within the component parameter range, the workpiece parameter range and the operational-status parameter range of the target cutting machine respectively, it is determined that the basic data of components, workpieces or the operational status of the target cutting machine is incorrect, and the data that is determined to be incorrect is deleted.

An embodiment of the disclosure relates to a cutting machine supplying and marketing system, which further includes a plurality of sensors connected with a plurality of components of the target cutting machine; wherein the cloud data evaluation module is used to evaluate the availability of the basic data according to the ratio of non-abnormal sensors to the plurality of sensors.

An embodiment of the disclosure relates to a cutting machine supplying and marketing system, wherein the cloud data evaluation module is used to check whether any piece of the basic data of components, workpieces and the operational status of a target cutting machine is blank, so as to evaluate the completeness of the basic data; if any piece of the basic data is blank, it is determined that the basic data is incomplete.

Another embodiment of the disclosure relates to a cutting machine supplying and marketing method, which includes the following steps: receiving the basic data of the components, the workpieces and the operation status of a target cutting machine by a target cutting machine data input module; recording the basic data by a cloud data ledger module; evaluating at least one of correctness, completeness, availability of the basic data and whether a connection ratio between the target cutting machine data input module and the cloud data ledger module is normal with a cloud data evaluation module, and thereby bonus points corresponding to the user device are calculated; comparing the basic data with an estimated component mechanical consumption data to generate a comparison result and transmitting a component purchase reminder message to a user device when the comparison result is less than a threshold by a cloud supplying module for the user device to determine whether an order has to be made; receiving an order message transmitted from the user device and generating a transaction record according to the order message by the cloud supplying module; querying a model, components of the target cutting machine and the bonus points corresponding to the user device that are related to the order message with a query module; and receiving the order message with a comparison module, and confirming whether information stored in a component purchase reminder message matches that in the order message with the comparison module.

Another embodiment of the disclosure relates to a cutting machine supplying and marketing method, which further includes the following steps: storing a record of deduction of bonus points with an inventory data ledger module, the record of deduction of bonus points is corresponding to the component purchase reminder message; wherein when the information in the component purchase reminder message matches that in the order message, storing a redeemed bonus-points record sent by the comparison module and the bonus credit record corresponds to the record of deduction of bonus points with the inventory data ledger module; and when the information in the component purchase reminder message does not match that in the order message, the inventory data ledger module receives a canceling message of a redeeming bonus points sent by the comparison module, and the record of the deduction of bonus points in the inventory data ledger module is deleted according to the canceling message of redeeming bonus points; wherein the information includes: the model of the target cutting machine, the consumption components of the target cutting machine, and the user device.

Another embodiment of the disclosure relates to a cutting machine supplying and marketing method, which further includes making comparisons with the cloud data evaluation module according to a component parameter range, a workpiece parameter range and an operational-status parameter range of the target cutting machine that are respectively corresponding to the basic data of components, workpieces and the operational status of the target cutting machine in order to evaluate the correctness of the basic data, and if the basic data of components, workpieces and the operational status of the target cutting machine do not fall within the component parameter range, the workpiece parameter range and the operational-status parameter range of the target cutting machine respectively, it is determined that the basic data of components, workpieces or the operational status of the target cutting machine is incorrect, and the data that is determined to be incorrect is deleted.

Another embodiment of the disclosure relates to a cutting machine supplying and marketing method, which further includes evaluating the availability of the basic data according to the ratio of non-abnormal sensors to the plurality of sensors with the cloud data evaluation module; wherein a plurality of sensors is connected with a plurality of components of the target cutting machine.

Another embodiment of the disclosure relates to a cutting machine supplying and marketing method, which further includes that the cloud data evaluation module is used to check whether any piece of the basic data of components, workpieces and the operational status of a target cutting machine is blank, so as to evaluate the completeness of the basic data; if any piece of the basic data is blank, it is determined that the basic data is incomplete.

Still another embodiment of the disclosure relates to a cutting machine supplying and marketing system, which includes a plurality of sensors, a cloud analysis device, a cloud data ledger module and a cloud supply module. The sensors are connected to a plurality of components of a target cutting machine implementing a machining process respectively to provide the operational data of the components. The cloud analysis device analyzes the operational data of the components to generate the analysis results of the components and generate the healthy statuses of the components according to the analysis results of the components. The cloud data ledger module records the healthy statuses of the components. The cloud supplying module transmits a component purchase reminder message to a user device according to the healthy statuses of the components for the user device to determine whether an order has to be made. The cloud supplying module receives an order message transmitted from the user device to generate a transaction record.

Further still another embodiment of the disclosure relates to a cutting machine supplying and marketing method, which includes the following steps: connecting a plurality of sensors to a plurality of components of a target cutting machine implementing a machining process respectively to provide the operational data of the components; analyzing the operational data of the components to generate the analysis results of the components and generating the healthy statuses of the components according to the analysis results of the components by a cloud analysis device; recording the healthy statuses of the components by a cloud data ledger module; transmitting a component purchase reminder message to a user device according to the healthy statuses of the components by a cloud supplying module for the user device to determine whether an order has to be made; and receiving an order message transmitted from the user device to generate a transaction record by the cloud supplying module.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The disclosure will become more fully understood from the detailed description given herein below and the accompanying drawings which are given by way of illustration only, and thus are not limitative of the disclosure and wherein:

FIG. 1A is a block diagram of a cutting machine supplying and marketing system in accordance with a first embodiment of the disclosure.

FIG. 1B is a block diagram of a cutting machine supplying and marketing system in accordance with another embodiment of the disclosure.

FIG. 1C is examples of giving bonus points of a cutting machine supplying and marketing system in accordance with another embodiment of the disclosure.

FIG. 2A is a flow chart of the first embodiment of the disclosure.

FIG. 2B is a flow chart of another embodiment of the disclosure.

FIG. 2C is a flow chart of another embodiment of the disclosure.

FIG. 2D is a flow chart of another embodiment of the disclosure.

FIG. 2E is a flow chart of another embodiment of the disclosure.

FIG. 2F is a flow chart of another embodiment of the disclosure.

FIG. 3 is a block diagram of a cutting machine supplying and marketing system in accordance with a second embodiment of the disclosure.

FIG. 4 is a flow chart of the second embodiment of the disclosure.

FIG. 5 is a block diagram of a cutting machine supplying and marketing system in accordance with a third embodiment of the disclosure.

FIG. 6 is a first flow chart of the third embodiment of the disclosure.

FIG. 7 is a second flow chart of the third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

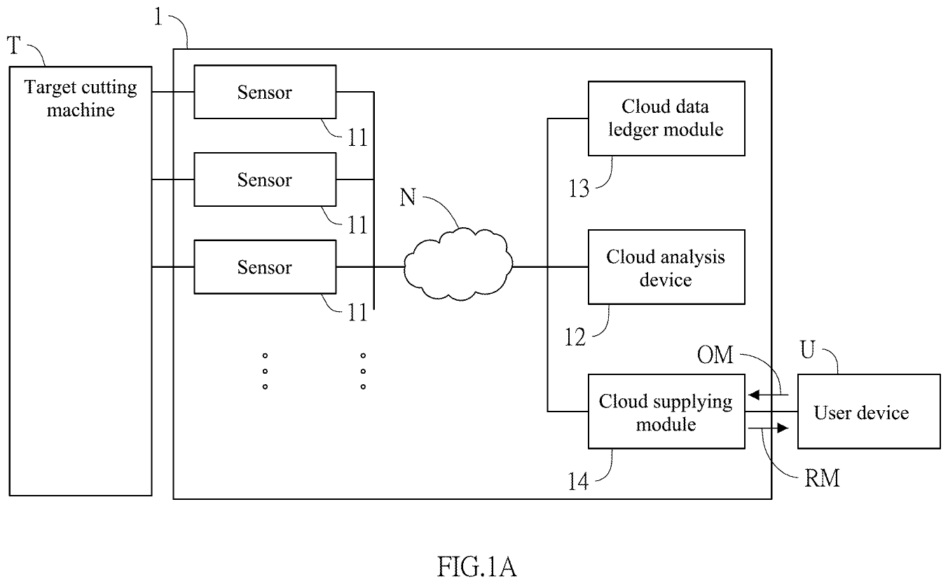

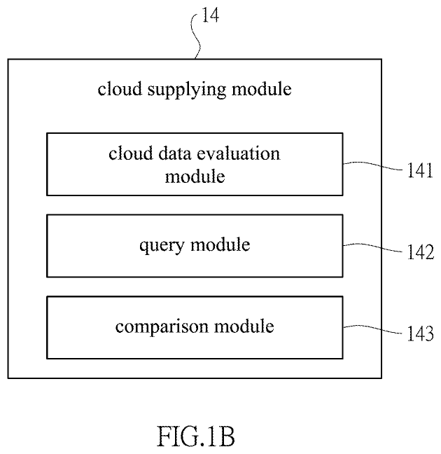

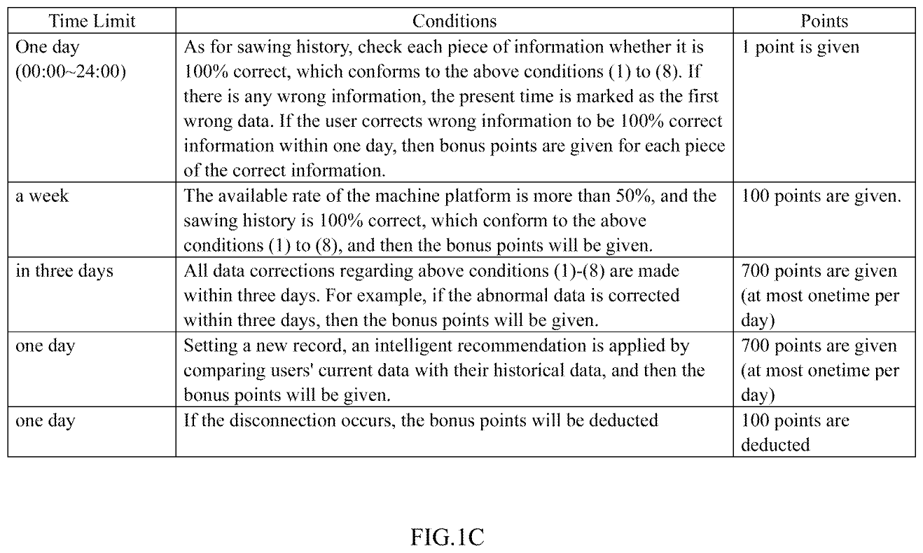

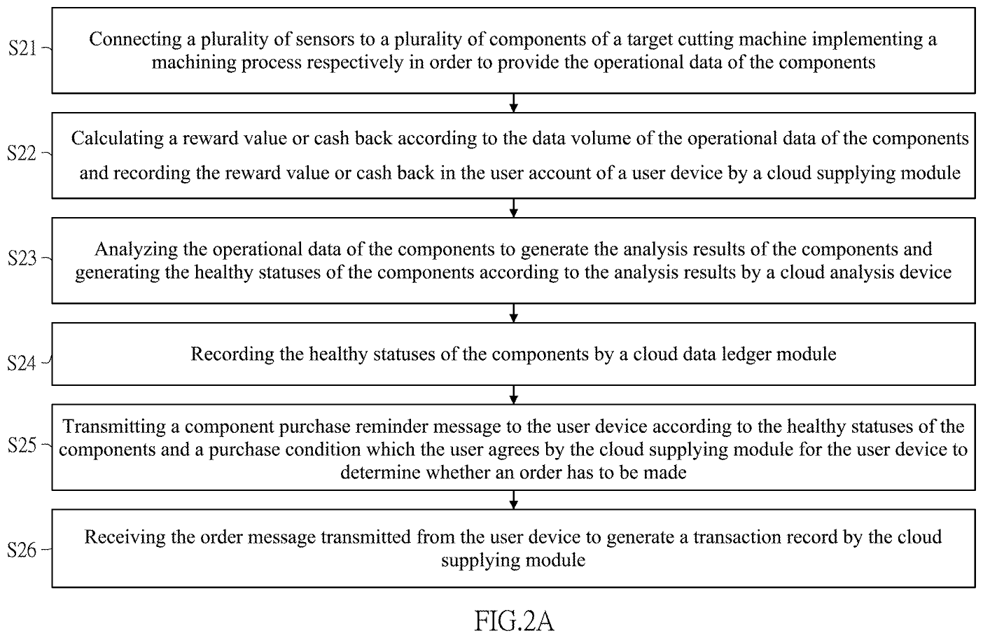

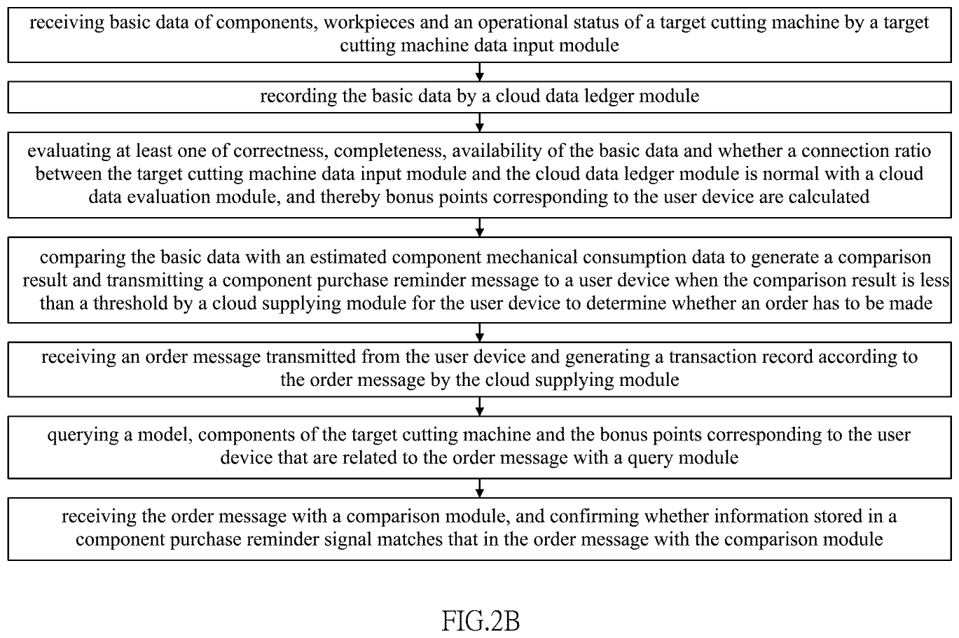

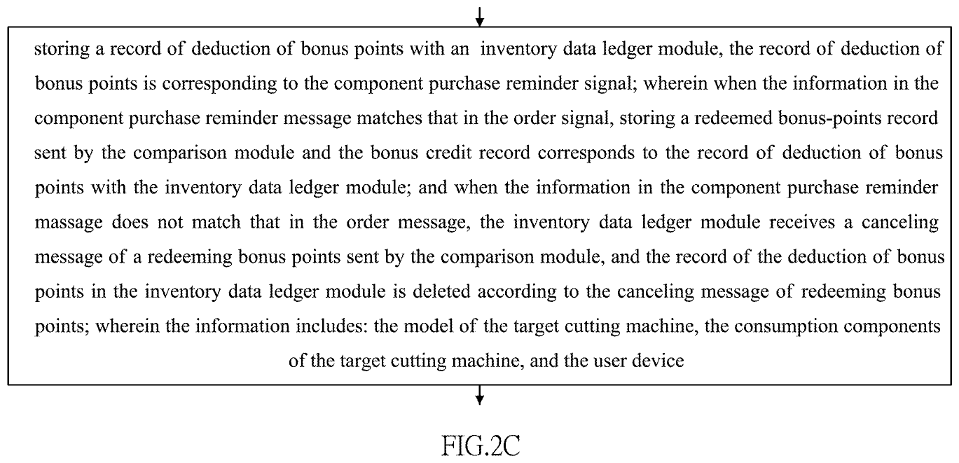

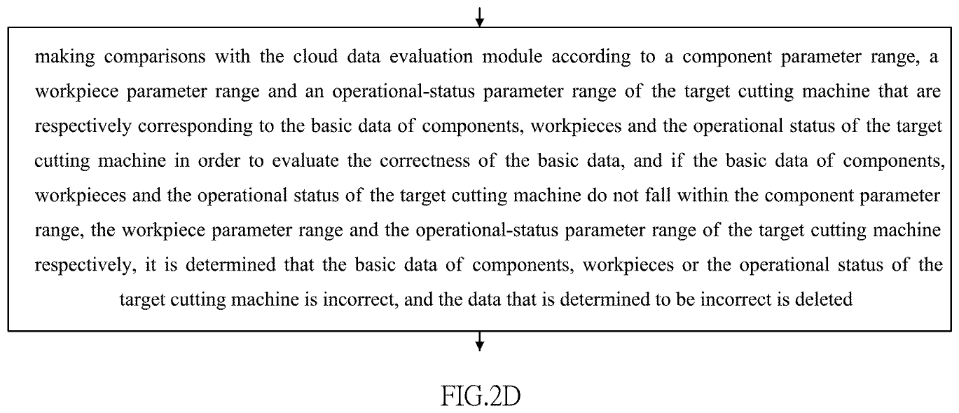

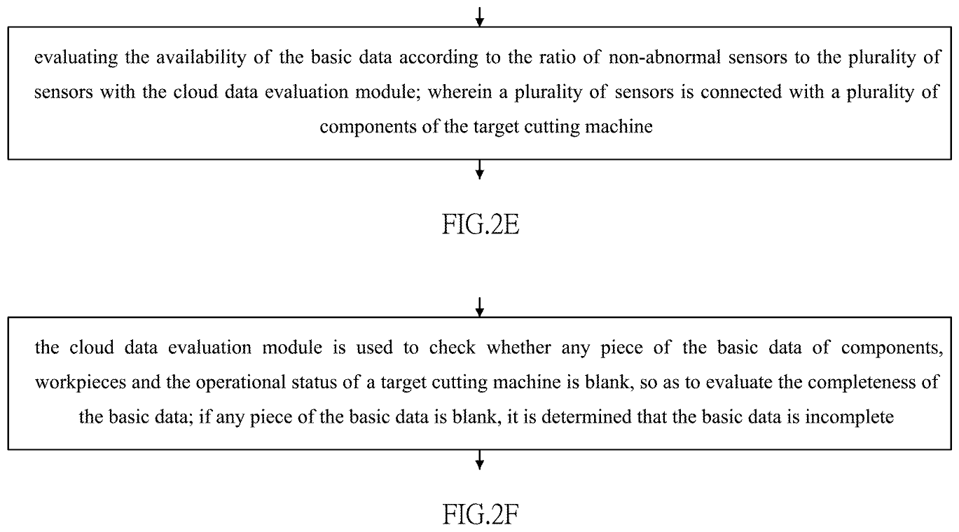

Refer to FIG. 1A, the disclosure provides a cutting machine supplying and marketing system, comprising a plurality of sensors 11, a cloud analysis device 12, a cloud data ledger module 13 and a cloud supplying module 14. Refer to FIG. 2B, the disclosure provides a cutting machine supplying and marketing method, comprising:

receiving basic data of components, workpieces and an operational status of a target cutting machine by a target cutting machine data input module;
recording the basic data by a cloud data ledger module;
evaluating at least one of correctness, completeness, availability of the basic data and whether a connection ratio between the target cutting machine data input module and the cloud data ledger module is normal with a cloud data evaluation module, and thereby bonus points corresponding to the user device are calculated;
comparing the basic data with an estimated component mechanical consumption data to generate a comparison result based on which the replacement of the components and the workpieces, and transmitting a component purchase reminder message to a user device when the comparison result is less than a threshold by a cloud supplying module for the user device to determine whether an order has to be made;
receiving an order message transmitted from the user device and generating a transaction record according to the order message by the cloud supplying module;
querying a model, components of the target cutting machine and the bonus points corresponding to the user device that are related to the order message with a query module;
receiving the order message with a comparison module, and confirming whether information stored in a component purchase reminder message matches that in the order message with the comparison module.

The system and method of the present disclosure will be described in detail below. Please refer to FIG. 1A, which is a block diagram of a cutting machine supplying and marketing system in accordance with a first embodiment of the disclosure. As shown in FIG. 1A, the system 1 includes the plurality of sensors 11, the cloud analysis device 12, the cloud data ledger module 13 and the cloud supplying module 14.

The target cutting machine data input module 16 is connected to a target cutting machine T, and connected to the cloud data ledger module 13 and the cloud supplying module 14 via a network N. The target cutting machine data input module 16 is for a user to input the basic data of the components, the workpiece and the operational status of the target cutting machine T; or the target cutting machine data input module 16 is used for receiving the basic data of the components, the workpiece and the operational status of the target cutting machine T from other database. In one embodiment, the basic data of the components may include one or more of the basic data of a bandsaw, a steel brush, a cutting oil tank, a gear box, a motor, a spindle, etc. In one embodiment, the basic data of the components of the target cutting machine T include component model. The basic data of the workpieces may include one or more of workpiece model, workpiece shape, workpiece size, workpiece material, etc. The basic data of the operational status may include total cutting hours, blade speeds, saw positions, main power current, hydraulic motor current, blade motor current, etc. Further, the target cutting machine data input module 16 is provided with preset data entry fields and displayed them on a screen for the user to input the basic data of the components, the workpiece and the operational status of the target cutting machine T, and then stored such data in a cloud database via a neural network model 144.

The sensors 11 are disposed on the target cutting machine T and connected to a plurality of components of the target cutting machine T respectively; the sensors 11 are further connected to the cloud analysis device 12, the cloud data ledger module 13 and the cloud supplying module 14 via a network N. The target cutting machine T implements a machining process for a workpiece; the sensors 11 detect the operational data of the components corresponding thereto respectively and provide the operational data of the components. In one embodiment, the sensors 11 may include two or more of a vibration sensor, a temperature sensor, a sound sensor, an image sensor or other similar sensors. For example, the sensor 11 may include an optoelectronic sensor, a first reflecting plate and a second reflecting plate; an accelerometer, proximity switch; a resistance ruler and a pull-wire base; a laser rangefinder . . . etc. In one embodiment, the components may include one or more of a bandsaw, a steel brush, a cutting oil tank, a gear box, a motor, a spindle, etc. In one embodiment, the operational data of each of the component may include one or more of a vibration signal, a temperature signal, an image signal, a sound signal, etc.

The cloud analysis device 12 can generate the analysis results of the components by analyzing the operational data of the components via distributed ledger technology, and generate the healthy statuses of the components according to the analysis results of the components. In one embodiment, the healthy status of the component may be the residual service life, the number of the residual cutting time or the damage status of the component.

The cloud data ledger module 13 records the healthy statuses of the components.

The cloud supplying module 14 transmits a component purchase reminder message RS to the user device U according to the healthy statuses of the components. More specifically, the cloud supplying module 14 can generate the component purchase reminder message RS according to the healthy statuses of the components and a purchase condition which the user agrees. For instance, if the purchase condition includes purchasing a spare for one component in advance when the residual service life of the components is less than one month, the cloud supplying module 14 can generate the component purchase reminder message RS and transmit the component purchase reminder message RS to the user device U when the residual service life of the component is less than one month.

Then, the user device U transmits an order message OS to the cloud supplying module 14 according to the component purchase reminder message RS. Afterward, the cloud supplying module 14 generates a transaction record according to the order message OS. Via the above method, the user can purchase enough spares for the components before the components need to be replaced, so the cutting machines of the user can always work normally.

In addition, the cloud supplying module 14 can further calculate reward values or cash back according to the data volume of the operational data, transmitted by the sensors 11, of the components and record the reward values or cash back in the user account of the user device U. Via the above method, when the user transmits the order message OS to make the order, the reward values or cash back can serve as the discount in the payment, so the user will be more willing to provide more operational data for analysis, and purchase more cutting machines and the components thereof. Therefore, the above method can also effectively increase the sales volume of the supplier's products.

Refer to FIG. 1B, in another embodiment, the cloud supplying module 14 further includes a cloud data evaluation module 141, the cloud data evaluation module 141 is used to evaluate at least one of correctness, completeness, availability of the basic data transmitted from the cloud data ledger module 13 and whether a connection ratio between the target cutting machine data input module 16 and the cloud data ledger module 13 is normal, and thereby bonus points corresponding to the user device are calculated. In other words, the cloud data evaluation module 141 of the present disclosure is used to calculate the corresponding bonus points and give the user or the user device the corresponding bonus points according to at least one of correctness, completeness, availability of the basic data and whether a connection ratio between the target cutting machine data input module 16 and the cloud data ledger module 13 is normal or not. The mechanism for calculating and giving bonus points of the present disclosure will be explained hereinafter in order to encourage the user or the user device to provide high-level data and maintain a stable and good connection ratio. In another embodiment, the cloud data evaluation module 141 is used to evaluate at least one of correctness, completeness, availability of the basic data transmitted from the cloud data ledger module 13, whether a connection ratio between the target cutting machine data input module 16 and the cloud data ledger module 13 is normal and the operational data transmitted by the sensors 11, and thereby bonus points corresponding to the user device are calculated.

The bonus point mechanism of the present invention is described as follows together with FIG. 1C. The cloud data evaluation module 141 evaluates at least one of correctness, completeness, availability of the basic data and whether a connection ratio between the target cutting machine data input module 16 and the cloud data ledger module 13 is normal. The at least one of correctness, completeness, availability of the basic data and whether a connection ratio between the target cutting machine data input module 16 and the cloud data ledger module 13 is normal is used as evaluation conditions for evaluating data quality, comprising following conditions: (1) whether the disconnect ratio (or disconnect rate) is normal: for example, uploading a piece of data to the cloud data ledger module 13 every two minutes in a normal disconnect ratio; (2) The correctness of each data column (each sensor outlier); (3) whether the order data column is blank; (4) whether the material input information (such as material name) is blank; (5) whether the material shape input information is blank; (6) whether the material width and height input information is blank (material width*height); (7) whether the saw band name input information is blank (Brand, Material, Type, TPI); (8) whether the range of the cumulative area of the saw band is abnormal, which represents that the saw band has not been changed for a long time).

Moreover, in other embodiments, other sources of bonus points of the present disclosure include: the conversion of data evaluation data into bonus points, the filling of satisfaction questionnaires by intelligent customer service, commodity exchange, new orders/cancellation of orders, and an overdue record of the previous year at the beginning of each year. Furthermore, in these embodiments, the present disclosure can put or store the bonus points described above into the block-chain to provide each user or each user device with cryptocurrency exclusive to specific manufacturers or organizations.

Refer to FIG. 1C. For example, the cloud data evaluation module 141 checks whether the sawing data meets the above conditions (1) to (8) one by one under the condition that the time range is one day, and 1 bonus point is given for each correct data. Moreover, for example, under the condition that the time range is one week, if the available rate is more than 50%, the calculation of the available rate is the actual sawing cumulative time/shift setting number and the sawing history is 100% correct, then 100 bonus points are given. Furthermore, if the user completes the correction of the sawing data in the conditions (1)˜(8) within three days, and then 700 points are given (once a day at most). Furthermore, if the user sets a new record compared with its own machine under the condition that the time range is one day, and then 700 points will be given (once a day at most). Furthermore, if the connection is disconnected within one day and then 100 points will be deducted.

Refer to FIGS. 2B to 2F, in another embodiment, the cloud data evaluation module 141 makes comparisons according to a component parameter range, a workpiece parameter range and an operational-status parameter range of the target cutting machine that are respectively corresponding to the basic data of components, workpieces and the operational status of the target cutting machine in order to evaluate the correctness of the basic data. The component parameter range, the workpiece parameter range and the operational-status parameter range of the target cutting machine respectively define a normal range in which the target cutting machine can work normally. The definition principle of the component parameter range, the workpiece parameter range and the operational-status parameter range of the target cutting machine respectively is the median, average, mode, etc. of the basic data of components, workpieces and the operational status of the target cutting machine from the cloud database recorded by the cloud data ledger module; or, the median, average, and mode of the basic data of components, workpieces and the operational status of the target cutting machine respectively are added or subtracted by 50%, %25. %10, %5, etc. to obtain the component parameter range, the workpiece parameter range and the operational-status parameter range of the target cutting machine respectively; or, further, the definition principle of the component parameter range, the workpiece parameter range and the operational-status parameter range of the target cutting machine respectively can also be defined by comparing the basic data with the actual operation data through the neural network model 144 based on predetermine conditions. If the basic data of components, workpieces and the operational status of the target cutting machine do not fall within the component parameter range, the workpiece parameter range and the operational-status parameter range of the target cutting machine respectively, it is determined that the basic data of components, workpieces or the operational status of the target cutting machine is incorrect, and the incorrect data is to be deleted, adjusted or corrected. Furthermore, as mentioned above, for the user, providing incorrect information will result in getting less bonus points, so as to encourage the user to provide correct information as much as possible. For example, a certain model of cutting machine can only process workpiece with a material width and height 1-500 mm, that is, the workpiece parameter range for the material width and height are both 1-500 mm, but the width and height of the sensed data are ranged from 650 to 1000 mm, that is, the data is abnormal (outlier), which indicates that there may be a problem in such sensor used to sense the size of the material. This abnormal data should be excluded, that is, such basic data should be determined to be incorrect, and the basic data should be deleted or adjusted or corrected.

Moreover, refer to FIGS. 2B to 2F, in another embodiment, the cutting machine supplying and marketing system further includes a plurality of sensors connected with a plurality of components of the target cutting machine, and these sensors can be various kinds of sensors installed on the sawing equipment and will not be described in detail here. The cloud data evaluation module 141 is used to evaluate the availability of the basic data according to the ratio of non-abnormal sensors to the plurality of sensors. For example, in one embodiment, if there are 8 sensors in one machine, and the value detected by one of the sensors is abnormal, then the calculation of the availability is (8−1)/8=87.5% on the day before the calculation deadline. If the availability threshold is set to be 85%, and then the availability of this embodiment is qualified to obtain the corresponding bonus points; if the availability threshold is set to 90%, then the availability of this embodiment fails to obtain the corresponding bonus points. Therefore, the more usable data for the user are provided, the more bonus points would be obtained by the user, so as to encourage the user to provide as much available data as possible.

Moreover, refer to FIGS. 2B to 2F, in another embodiment, the cloud data evaluation module 141 is used to check whether any piece of the basic data of components, workpieces and the operational status of a target cutting machine is blank, so as to evaluate the completeness of the basic data. If any piece of the basic data is blank, it is determined that the basic data is incomplete. In another embodiment, the cloud data evaluation module 141 also can be set to determine that the basic data is incomplete only when some specific data set or are blank. Therefore, the more complete data are provided, the more bonus points are obtained for the user, so as to encourage the user to provide complete data as much as possible.

Moreover, refer to FIGS. 2B to 2F, in another embodiment, the cloud data evaluation module 141 is used to evaluate whether a connection ratio between the target cutting machine data input module 16 and the cloud data ledger module 13 is normal. For example, Cumulative disconnection time of one day is: (1) 03:16:10˜03:16:40, that is 30 seconds; (2) 17:25:40˜47:27:10, that is 90 seconds; (3) 17:30:00˜47:31:20, that is 80 seconds; (4) 17:38:40˜47:44:10, that is 330 seconds; (5) 17:48:10˜47:48:40, that is 30; (6) 17:52:10˜47:57:40, that is 330 seconds; total: 890 seconds; cumulative time: 03:16:10˜47:57:40, that is 52890 seconds; connection ratio: (52890−890)/52890=98.3%. If the connection ratio threshold is set to be 98%, the connection ratio in this embodiment is qualified to obtain corresponding bonus points; if the connection ratio is set to be 99%, the connection ratio in this embodiment is not qualified to obtain corresponding bonus points.

Moreover, refer to FIGS. 2B to 2F, in another embodiment, the cloud supplying module further includes: a query module 142 and a comparison module 143. The query module 142 is used for querying a model, components of the target cutting machine and the bonus points corresponding to the user device that are related to the order message. For example, the query module 142 is used to querying the model of the target cutting machine corresponding to the order message, the components of the target cutting machine that have been ordered by the user, and the accumulated bonus points corresponding to the user device or the user currently. In this embodiment, the model of the sawing equipment corresponding to the order message the query module 142 queries is SAHA-1, and the components of the target cutting machine corresponding to the order message, such as saw band, steel brush, cutting oil and gear box, are ordered by the user; the corresponding accumulated bonus point value of the user device is 10000 currently corresponding to the user or the user device. And, in another embodiment, the query module 142 is further used for querying the bonus redeeming condition corresponding to the user device or the user at present. For example, the bonus exchange condition is that 1,000 bonus points can be used for exchanging a single set of gearboxes; double bonus points can be used for joint purchases of saw bands, steel brushes and cutting oil, etc.

Further, refer to FIGS. 2B to 2F, in another embodiment, the comparison module 143 is used for receiving the order message, and confirming whether information stored in a component purchase reminder message matches that in the order message. Further, in another embodiment, the information includes: the model of the target cutting machine, consumption components of the target cutting machine based on the estimated component mechanical consumption data and a purchase condition with which the user agrees, and the user device. For example, the model of the cutting machine purchased by the user is SAHA-1, and the comparison module 143 confirms that the components corresponding to this model should be saw bands, steel brushes, cutting oil and gear boxes of a certain number corresponding to SAHA-1; and the comparison module 143 also confirms that the saw bands, steel brushes, cutting oil, and gear boxes are matched with the consumption components of the target cutting machine based on the estimated component mechanical consumption data. It can be seen from this that if the comparison module 143 confirms that the information stored in a component purchase reminder message does not match that in the order message, for example, the consumption components of the target cutting machine do not match the components ordered by the user, it indicates that the components ordered by the user may be wrong components. Therefore, such a comparison mechanism of the present disclosure can effectively check whether the components ordered by the user are those recommended by the cloud supplying modules 14 that are generated from the component purchase reminder message according to the estimated component mechanical consumption data and a purchase condition with which the user agrees when the user places the order, so as to prevent users from ordering unnecessary components, which would incur additional cost for the users. Please note that the neural network model 144 is further used to save the estimated component mechanical consumption data. The neural network model 144 can be established by a training process in advance. During the training process, the cloud supplying module 14 collects the historical data from the target cutting machines, which may include the above basic data transmitted from the cloud data ledger module 13, the connection ratio between the target cutting machine data input module 16 and the cloud data ledger module 13 and the operational data, such as rotational speeds of cutting tools, feed rates of cutting, tools, currents of motors, hydraulic temperatures, temperatures of coolants, temperatures of gear boxes, vibration data, accumulated cutting areas, offsets of cutting tools (e.g. bandsaw), model of machine, model of workpiece, model of cutting tool, teeth number of cutting tool, material of cutting tool, etc. The above data can be pre-processed and normalized through Big Data analysis in order to establish the neural network model 144. Finally, the cloud supplying module 14 can obtain the estimated component mechanical consumption data via the neural network model 144. Further, in another embodiment, the cloud supplying module 14 receives the actual component mechanical data of the target cutting machine performing the machining process from the sensors 11 and the cloud supplying module 14 performs a comparison process. During the comparison process, the cloud supplying module 14 compares the actual component mechanical data with the basic data in order to generate the estimated component mechanical consumption data.

Moreover, refer to FIGS. 2B to 2F, in another embodiment, the cutting machine supplying and marketing system further includes an inventory data ledger module 15 for storing a record of deduction of bonus points. The record of deduction of bonus points is corresponding to the component purchase reminder message, and the generation of the record of deduction of bonus points represents that bonus points will be deduced if the following condition is fulfilled; wherein when the information in the component purchase reminder message matches that in the order message, the inventory data ledger module 15 is used to store a redeemed bonus-points record sent by the comparison module 143 and the bonus credit record corresponds to the record of deduction of bonus points; and when the information in the component purchase reminder message does not match that in the order message, the inventory data ledger module 15 receives a canceling message of a redeeming bonus points sent by the comparison module 143, and the record of the deduction of bonus points in the inventory data ledger module 15 is deleted according to the canceling message of redeeming bonus points. In another embodiment, when the information in the component purchase reminder message does not match that in the order message, the inventory data ledger module 15 receives a canceling message of redeeming bonus points sent by the comparison module 143 and notices the users to check their orders first, and if the users confirm that their orders are correct, the record of the deduction of bonus points in the inventory data ledger module 15 is not deleted. Therefore, such technical scheme of the present disclosure can effectively redeem the bonus points while check whether the components ordered by the user match those recommended by the cloud supplying modules 14 that are generated from the component purchase reminder message according to the estimated component mechanical consumption data and a purchase condition to which the user agrees when the user places the order. If the recommended components do not match the components ordered by the user as mentioned above, the bonus points will not be redeemed, so as to prevent the user from placing an order for unnecessary parts and wasting bonus points for nothing useful.

Furthermore, refer to FIGS. 2B to 2F, in another embodiment, the cloud data evaluation module 141 of the present disclosure is further used to perform data calculation on the one with the highest cumulative area generated by the saw band materials, the sawing materials (the materials to be sawed) and the widths of the materials, and provide other users with those optimal saw band materials, those optimal sawing materials (materials to be sawed) and those optimal widths of the material. For example, a factory expects to cut material with a bi-metal saw belt in S45C material with a material width between 200 mm and 300 mm. The cloud data evaluation module 141 of the present disclosure uses the above-mentioned working conditions, that is, the saw band material, sawing material and width as the limiting conditions and searches for all qualified saw band cutting records on the cloud data ledger module 13, and cumulative cutting areas corresponding to above data are sorted, and the processing parameters used by the saw band with the highest cumulative cutting area are recommended to other users or user devices. Therefore, the method and system of the present disclosure can recommend the optimal processing parameters to each user in real time according to the above-mentioned calculation process according to different models, saw band materials, and sawing materials, etc.

The embodiment just exemplifies the disclosure and is not intended to limit the scope of the disclosure. Any equivalent modification and variation according to the spirit of the disclosure is to be also included within the scope of the following claims and their equivalents.

Please refer to FIG. 2A, which is a flow chart of the first embodiment of the disclosure. As shown in FIG. 2A, the cutting machine supplying and marketing method in accordance with the first embodiment may include the following steps:

Step 21: connecting a plurality of sensors to a plurality of components of a target cutting machine implementing a machining process respectively in order to provide the operational data of the components.

Step 22: calculating a reward value or cash back according to the data volume of the operational data of the components and recording the reward value or cash back in the user account of a user device by a cloud supplying module.

Step S23: analyzing the operational data of the components to generate the analysis results of the components and generating the healthy statuses of the components according to the analysis results by a cloud analysis device.

Step S24: recording the healthy statuses of the components by a cloud data ledger module.

Step S25: transmitting a component purchase reminder message to the user device according to the healthy statuses of the components and a purchase condition which the user agrees by the cloud supplying module for the user device to determine whether an order has to be made.

Step S26: receiving the order message transmitted from the user device to generate a transaction record by the cloud supplying module.

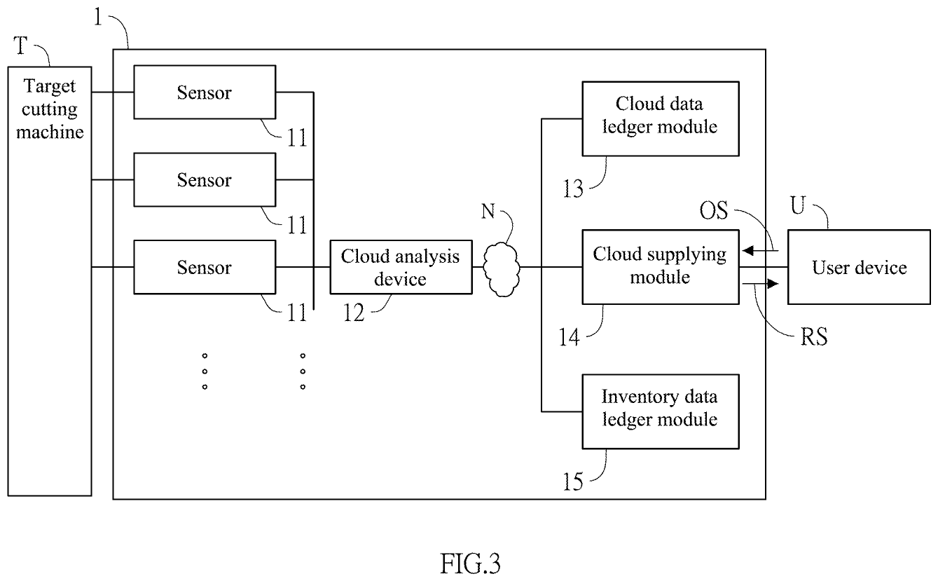

Please refer to FIG. 3, which is a block diagram of a cutting machine supplying and marketing system in accordance with a second embodiment of the disclosure. As shown in FIG. 3, the system 1 includes a plurality of sensors 11, a cloud analysis device 12, a cloud data ledger module 13 and a cloud supplying module 14.

The sensors 11 are disposed on the target cutting machine T and connected to a plurality of components of the target cutting machine T respectively. The target cutting machine T implements a machining process for a workpiece and the sensors 11 detects the operational data of the components corresponding thereto and provide the operational data of the components.

The difference between the embodiment and the previous embodiment is that the cloud analysis device 2 can be disposed at the customer's location, connected to the sensors 11, and connected to the cloud data ledger module 13 and the cloud supplying module 14 via a network N. Similarly, the cloud analysis device 12 can also generate the analysis results of the components by analyzing the operational data of the components via distributed ledger technology, and generate the healthy statuses of the components according to the analysis results of the components.

The cloud data ledger module 14 records the healthy statuses of the components.

In addition, the cloud supplying module 14 can further calculate reward values or cash back according to the data volume of the healthy statuses recorded in the cloud data ledger module 13 and record the reward values or cash back in the user account of a user device U.

Similarly, the cloud supplying module 14 can generate the component purchase reminder message RS according to the healthy statuses of the components and a purchase condition which the user agrees, and transmits the component purchase reminder message RS to the user device U.

Then, the user device U can transmit an order message OS according to the component purchase reminder message RS to the cloud supplying module 14 and the cloud supplying module 14 generates a transaction record according to the order message OS.

As described above, the cloud analysis device 12 can be disposed at the customer's location to directly analyze the operational data of the components and then generate the healthy statuses of the components. Afterward, the healthy statuses of the components can be transmitted to the cloud data ledger module 13 and the cloud supplying module 14 can calculate the reward values or cash back according to the data volume of the healthy statuses recorded in the cloud data ledger module 13.

In the embodiment, the system 1 can further include an inventory data ledger module 15. The inventory data ledger module 15 records the inventory of the components and updates the inventory of the components according to the transaction records. In this way, the supplier of the cutting machines and the components thereof can always know the inventory of the components and prepare enough spares for the components in order to avoid that the inventory of the components is insufficient.

Further, the cloud analysis device 12 can further generate the test data of the components by analyzing the healthy statuses of the components via distributed ledger technology. Via the above method, the cloud analysis device 12 can obtain the actual performances of the target cutting machine T and the components thereof according to the operational data provided by the target cutting machine T, which can serve as the references for marketing the products and improving the performances thereof.

The embodiment just exemplifies the disclosure and is not intended to limit the scope of the disclosure. Any equivalent modification and variation according to the spirit of the disclosure is to be also included within the scope of the following claims and their equivalents.

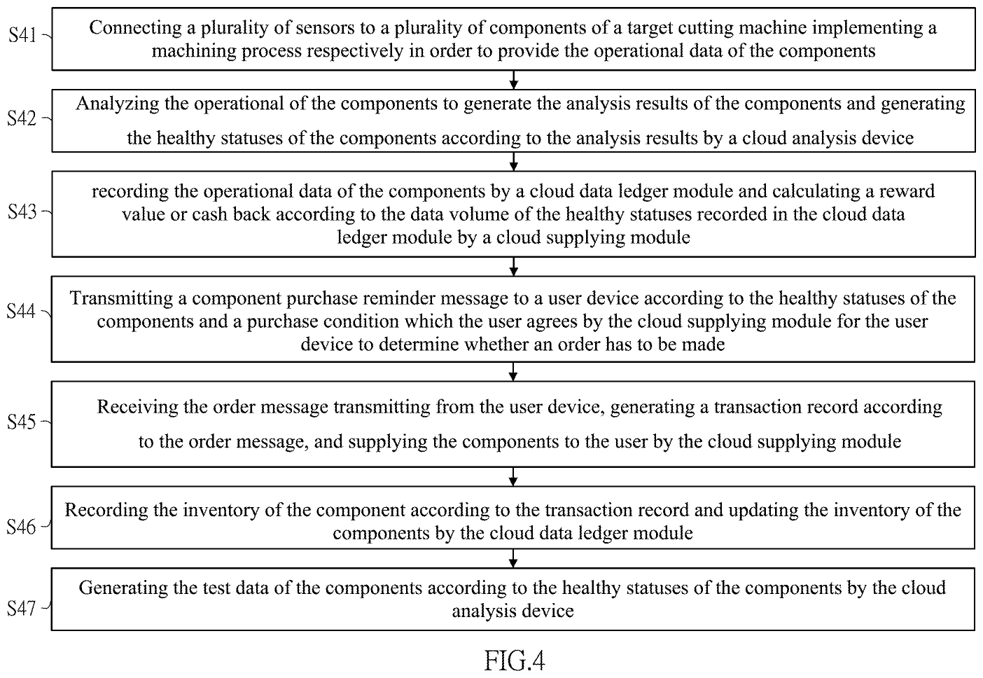

Please refer to FIG. 4, which is a flow chart of the second embodiment of the disclosure. As shown in FIG. 4, the cutting machine supplying and marketing method in accordance with the second embodiment may include the following steps:

Step 41: connecting a plurality of sensors to a plurality of components of a target cutting machine implementing a machining process respectively in order to provide the operational data of the components.

Step 42: analyzing the operational of the components to generate the analysis results of the components and generating the healthy statuses of the components according to the analysis results by a cloud analysis device.

Step 43: recording the operational data of the components by a cloud data ledger module and calculating a reward value or cash back according to the data volume of the healthy statuses recorded in the cloud data ledger module by a cloud supplying module.

Step 44: transmitting a component purchase reminder message to a user device according to the healthy statuses of the components and a purchase condition which the user agrees by the cloud supplying module for the user device to determine whether an order has to be made.

Step 45: receiving the order message transmitting from the user device, generating a transaction record according to the order message, and supplying the components to the user by the cloud supplying module.

Step 46: recording the inventory of the component according to the transaction record and updating the inventory of the components by the cloud data ledger module.

Step 47: generating the test data of the components according to the healthy statuses of the components by the cloud analysis device.

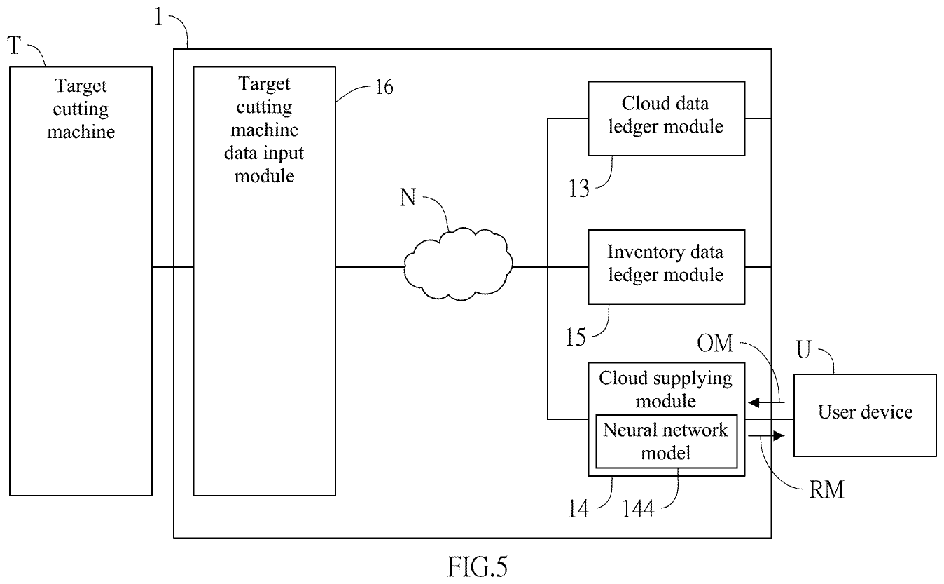

Please refer to FIG. 5, which is a block diagram of a cutting machine supplying and marketing system in accordance with a third embodiment of the disclosure. As shown in FIG. 5, the system 1 includes a target cutting machine data input module 16, a cloud data ledger module 13, a cloud supplying module 14 and an inventory data ledger module 15.

The target cutting machine data input module 16 is connected to a target cutting machine T, and connected to the cloud data ledger module 13 and the cloud supplying module 14 via a network N. The target cutting machine data input module 16 is for a user to input the basic data of the components, the workpiece and the operational status of the target cutting machine T. In one embodiment, the components may include one or more of a bandsaw, a steel brush, a cutting oil tank, a gear box, a motor, a spindle, etc. In one embodiment, the basic data of the components of the target cutting machine T include component model. The basic data of the workpieces may include one or more of workpiece model, workpiece shape, workpiece size, workpiece material, etc. The basic data of the operational status may include total cutting hours.

The cloud data ledger module 13 records the basic data.

The cloud supplying module 14 compares the basic data with the estimated component mechanical consumption data to generate a comparison result. When the comparison result is less than a threshold, the cloud supplying module 14 transmits a component purchase reminder message RS to a user device U. More specifically, the cloud supplying module 14 can generate the component purchase reminder message RS according to the estimated component mechanical consumption data and a purchase condition which the user agrees. For example, if the purchase condition includes purchasing a spare for one component in advance when the residual service life of the components is less than one month, the cloud supplying module 14 can generate the component purchase reminder message RS and transmit the component purchase reminder message RS to the user device U when the estimated component mechanical consumption data show that residual service life of the component is less than one month.

Then, the user device U transmits an order message OS to the cloud supplying module 14 according to the component purchase reminder message RS and the cloud supplying module 14 generates a transaction record according to the order message OS. Via the above method, the user can purchase enough spares for the components before the components need to be replaced, so the cutting machines of the user can always work normally.

In addition, the cloud supplying module 14 can further calculate reward values or cash back according to the data volume of the basic data recorded in the cloud data ledger module 13 and record the reward values or cash back in the user account of the user device U. Via the above method, when the user transmits the order message OS to make the order, the reward values or cash back can serve as the discount in the payment, so the user will be more willing to provide more basic data for analysis, and purchase more cutting machines and the components thereof. Therefore, the above method can also effectively increase the sales volume of the supplier's products.

Moreover, the cloud supplying module 14 further includes a neural network model 144. The cloud supplying module 14 compares the basic data of the target cutting machine T with the basic data of a plurality of default cutting machines stored in a cloud database via the neural network model 144 to calculate an estimated machining parameter, which may include an estimated cutting tool mechanical consumption rate. Afterward, the target cutting machine T implements a machining process according to the estimated machining parameter. Next, the cloud supplying module 14 executes a comparison process according to the actual mechanical consumption rate of the target cutting machine T implementing the machining process in order to compare the estimated cutting tool mechanical consumption rate with the actual mechanical consumption rate and then generate a suggested machining parameter. Then, the cloud supplying module 14 transmits the suggested machining parameter to the target cutting machine T for the target cutting machine T to execute the machining process by the suggested machining parameter. Further, the target cutting machine data input module 16 receives the above basic data, which may include model of machine, model of workpiece, model of cutting tool, etc. The cloud supplying module 14 further keeps collecting various operational data, such as operational status (e.g. rotational speed of cutting tool, feed rate of cutting tool, etc.), current of motor, hydraulic temperature, temperature of coolant, temperature of gear box, vibration data, accumulated cutting area, offset of cutting tool (e.g. bandsaw), from the target cutting machine via any networks. Then, the cloud supplying module 14 compares the basic data of the target cutting machine with the basic data of the above machine so as to confirm whether the basic data of the target cutting machine are corresponding to the training data of the neural network model 144. After the cloud supplying module 14 confirms that the basic data of the target cutting machine are corresponding to the training data of the neural network model 144, the cloud supplying module 14 pre-processes the collected data (e.g. removes the incorrect data and selects other proper data) and finds out estimated machining parameters matching the basic data of the target cutting machine according to the pre-processed data via the neural network model 144. At the same time, the cloud supplying module 14 calculates the estimated increase percentage of performing a machining process by the estimated machining parameters; the estimated machining parameters may include rotational speed of cutting tool, feed rate of cutting tool, etc. Afterward, the target cutting machine performs a machining process by the estimated machining parameters. Via the above method, the system 1 can actively provide the suggested machining parameters for the target cutting machine T, so the target cutting machine T can operate according to the best machining parameters, which can increase the satisfaction of the user and further increase the sales volume of the supplier's products. The neural network model 144 can also be established by a training process in advance. During the training process, the cloud supplying module 14 collects the historical data from above data, such as the actual mechanical consumption rate. The above data can be pre-processed and normalized via Big Data analysis in order to establish the neural network model 144. Finally, the suggested machining parameter can be generated via the neural network model 144.

In the embodiment, the system 1 further includes an inventory data ledger module 15. The inventory data ledger module 15 records the inventory of the components and updates the inventory of the components according to the transaction record. In this way, the supplier of the cutting machines and the components thereof can always know the inventory of the components and prepare enough spares for the components in order to avoid that the inventory of the components is insufficient.

The embodiment just exemplifies the disclosure and is not intended to limit the scope of the disclosure. Any equivalent modification and variation according to the spirit of the disclosure is to be also included within the scope of the following claims and their equivalents.

It is worthy to point out that the currently available marketing systems can provide only the common marketing management and inventory management functions, but cannot actively promote the products. Thus, the currently available marketing systems cannot effectively increase the sales volume of the cutting machines. On the contrary, according to one embodiment of the disclosure, the system can calculate the reward values or cash back according to the data volume of the operational data or the basic data, provided by the user device, recorded in the cloud data ledger module, and record the reward values or cash back in the user account of the user device. Therefore, the user will be more willing to purchase more cutting machines and the components thereof, so the sales volume of the supplier's products can be effectively increased.

Also, according to one embodiment of the disclosure, the system can actively provide the suggested machining parameters for the cutting machines of the user, so the cutting machines can operate according to the best machining parameters, which can increase the satisfaction of the user and further increase the sales volume of the supplier's products.

Besides, the currently available marketing systems can provide only the common marketing management and inventory management functions, but cannot acquire the operational data of the cutting machines from the customers. Therefore, the suppliers cannot understand the actual performances of the cutting machines and the components thereof. On the contrary, according to one embodiment, the system can generate the test data of the components according to the healthy statuses thereof in order to obtain the actual performances of the cutting machines and the components thereof, which can serve as the references for marketing the products and improving the performances thereof.

Moreover, the currently available marketing systems can record only the inventory of the cutting machines and the components thereof, but cannot obtain the demand of the customers, so the inventory of the cutting machines tends to be insufficient. On the contrary, according to one embodiment of the disclosure, the system can acquire the demand of the user and keep updating the inventory of all components according to the transaction records, so the inventory of all components can always be enough.

Furthermore, according to one embodiment of the disclosure, the system can transmit the component purchase reminder messages to the user device according to a purchase condition which the user agrees and the healthy statuses or the estimated component mechanical consumption data of the component for the user device to automatically make orders. Thus, the user can always have enough components, so the cutting machines of the user can always work normally. As described above, the system according to the embodiments of the disclosure can achieve unpredictable technical effects.

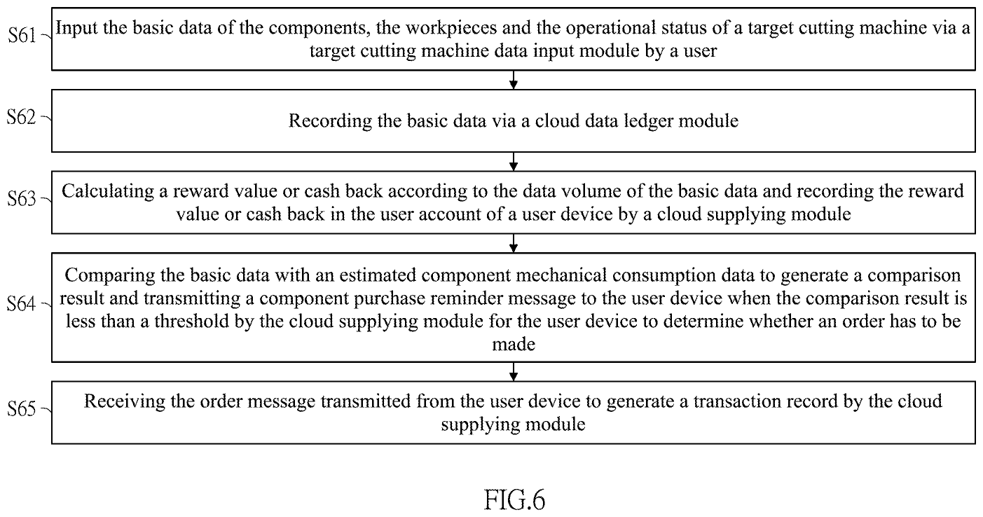

Please refer to FIG. 6, which is a first flow chart of the third embodiment of the disclosure. As shown in FIG. 6, the cutting machine supplying and marketing method in accordance with the third embodiment may include the following steps:

Step 61: input the basic data of the components, the workpieces and the operational status of a target cutting machine via a target cutting machine data input module by a user.

Step 62: recording the basic data via a cloud data ledger module.

Step 63: calculating a reward value or cash back according to the data volume of the basic data and recording the reward value or cash back in the user account of a user device by a cloud supplying module.

Step 64: comparing the basic data with an estimated component mechanical consumption data to generate a comparison result and transmitting a component purchase reminder message to the user device when the comparison result is less than a threshold by the cloud supplying module for the user device to determine whether an order has to be made.

Step 65: receiving the order message transmitted from the user device to generate a transaction record by the cloud supplying module.

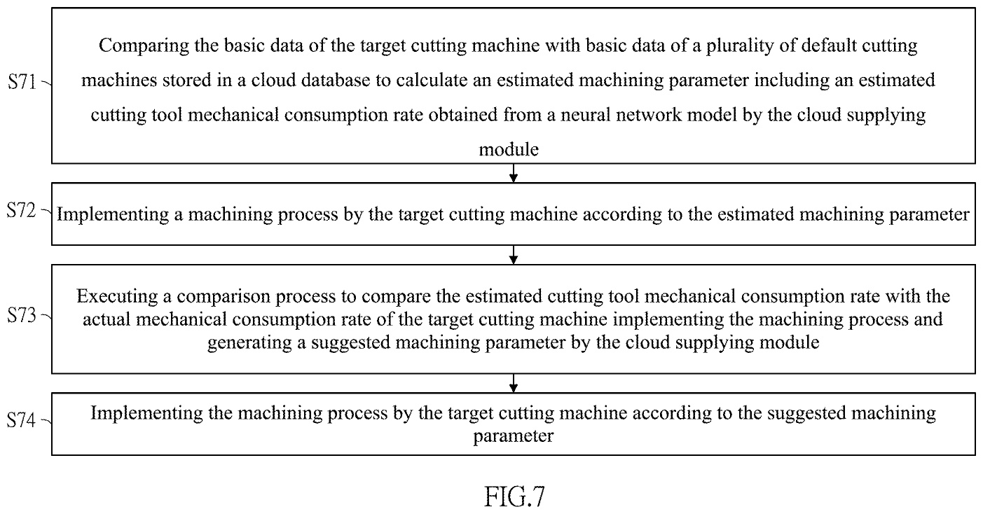

Please refer to FIG. 7, which is a second flow chart of the third embodiment of the disclosure. As shown in FIG. 7, the method of generating the suggested machining parameters in accordance with the third embodiment may further include the following steps:

Step 71: comparing the basic data of the target cutting machine with basic data of a plurality of default cutting machines stored in a cloud database to calculate an estimated machining parameter including an estimated cutting tool mechanical consumption rate obtained from a neural network model by the cloud supplying module.

Step 72: implementing a machining process by the target cutting machine according to the estimated machining parameter.

Step 73: executing a comparison process to compare the estimated cutting tool mechanical consumption rate with the actual mechanical consumption rate of the target cutting machine implementing the machining process and generating a suggested machining parameter by the cloud supplying module.

Step 74: implementing the machining process by the target cutting machine according to the suggested machining parameter.

To sum up, according to one embodiment of the disclosure, the system can transmit the component purchase reminder messages to the user device according to the purchase condition which the user agrees and the healthy statuses or the estimated component mechanical consumption data of the component for the user device to automatically make orders. Thus, the user can always have enough components, so the cutting machines of the user can always work normally.

Also, according to one embodiment of the disclosure, the system can calculate the reward values or cash back according to the data volume of the operational data or the basic data, provided by the user device, recorded in the cloud data ledger module, and record the reward values or cash back in the user account of the user device. Therefore, the user will be more willing to purchase more cutting machines and the components thereof, so the sales volume of the supplier's products can be effectively increased.

Besides, according to one embodiment of the disclosure, the system can actively provide the suggested machining parameters for the cutting machines of the user, so the cutting machines can operate according to the best machining parameters, which can increase the satisfaction of the user and further increase the sales volume of the supplier's products.

Moreover, according to one embodiment of the disclosure, the system can acquire the demand of the user and keep updating the inventory of all components according to the transaction records, so the inventory of all components can always be enough.

Furthermore, according to one embodiment, the system can generate the test data of the components according to the healthy statuses thereof in order to obtain the actual performances of the cutting machines and the components thereof, which can serve as the references for marketing the products and improving the performances thereof.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A cutting machine supplying and marketing system, comprising:
a target cutting machine data input module receiving basic data of components, workpieces and an operational status of a target cutting machine;
a cloud data ledger module recording the basic data; and
a cloud supplying module comparing the basic data with an estimated component mechanical consumption data to generate a comparison result, wherein when the comparison result is less than a threshold, the cloud supplying module transmits a component purchase reminder message to a user device for the user device to determine whether an order has to be made;
wherein the cloud supplying module receives an order message transmitted from the user device in order to generate a transaction record;
wherein the cloud supplying module further includes a cloud data evaluation module, the cloud data evaluation module is used to evaluate at least one of correctness, completeness, availability of the basic data thereby bonus points corresponding to the user device are calculated;
wherein the cloud supplying module further includes:
a comparison module, for receiving the order message, and confirming whether purchase reminder message matches the order message.

2. The cutting machine supplying and marketing system of claim 1, further including an inventory data ledger module for storing a record of deduction of bonus points, the record of deduction of bonus points is corresponding to the component purchase reminder message; wherein when the information in the component purchase reminder message matches that in the order message, the inventory data ledger module is used to store a redeemed bonus-points record sent by the comparison module and the bonus credit record corresponds to the record of deduction of bonus points; and when the information in the component purchase reminder message does not match that in the order message, the inventory data ledger module receives a canceling message of redeeming bonus points sent by the comparison module, and the record of the deduction of bonus points in the inventory data ledger module is deleted according to the canceling message of redeeming bonus points.

3. The cutting machine supplying and marketing system of claim 1, wherein the cloud data evaluation module makes comparisons according to a component parameter range, a workpiece parameter range and an operational-status parameter range of the target cutting machine that are respectively corresponding to the basic data of components, workpieces and the operational status of the target cutting machine in order to evaluate the correctness of the basic data, and if the basic data of components, workpieces and the operational status of the target cutting machine do not fall within the component parameter range, the workpiece parameter range and the operational-status parameter range of the target cutting machine respectively, it is determined that the basic data of components, workpieces or the operational status of the target cutting machine is incorrect, and the data that is determined to be incorrect is deleted.

4. The cutting machine supplying and marketing system of claim 1, further including a plurality of sensors connected with a plurality of components of the target cutting machine; wherein the cloud data evaluation module is used to evaluate the availability of the basic data according to the ratio of non-abnormal sensors to the plurality of sensors.

5. The cutting machine supplying and marketing system of claim 1, wherein the cloud data evaluation module is used to check whether any piece of the basic data of components, workpieces and the operational status of a target cutting machine is blank, so as to evaluate the completeness of the basic data; if any piece of the basic data is blank, it is determined that the basic data is incomplete.

6. The cutting machine supplying and marketing system of claim 1, wherein the inventory data ledger module records an inventory of the components and updates the inventory of the components according to the transaction record.

7. The cutting machine supplying and marketing system of claim 1, wherein the cloud supplying module automatically generates the component purchase reminder message according to the estimated component mechanical consumption data and a purchase condition.

8. The cutting machine supplying and marketing system of claim 1, wherein the cloud supplying module comprises a neural network model, and the cloud supplying module compares the basic data of the target cutting machine with basic data of a plurality of default cutting machines stored in a cloud database to calculate an estimated machining parameter comprising an estimated cutting tool mechanical consumption rate obtained from the neural network model, and the cloud supplying module executes a comparison process according to an actual mechanical consumption rate of the target cutting machine implementing a machining process in order to compare the estimated cutting tool mechanical consumption rate with the actual mechanical consumption rate and then generate a suggested machining parameter.

9. A cutting machine supplying and marketing method, comprising:
receiving basic data of components, workpieces and an operational status of a target cutting machine by a target cutting machine data input module;
recording the basic data by a cloud data ledger module;
evaluating at least one of correctness, completeness, availability of the basic data, and thereby bonus points corresponding to the user device are calculated;
comparing the basic data with an estimated component mechanical consumption data to generate a comparison result and transmitting a component purchase reminder message to a user device when the comparison result is less than a threshold by a cloud supplying module for the user device to determine whether an order has to be made;
receiving an order message transmitted from the user device and generating a transaction record according to the order message by the cloud supplying module;
querying a model, components of the target cutting machine and the bonus points corresponding to the user device that are related to the order message with a query module;
receiving the order message with a comparison module, and confirming whether information stored in a component purchase reminder message matches that in the order message with the comparison module.

10. The cutting machine supplying and marketing method of claim 9, further comprising: storing a record of deduction of bonus points with an inventory data ledger module, the record of deduction of bonus points is corresponding to the component purchase reminder message; wherein when the information in the component purchase reminder message matches that in the order message, storing a redeemed bonus-points record sent by the comparison module and the bonus credit record corresponds to the record of deduction of bonus points with the inventory data ledger module; and when the information in the component purchase reminder message does not match that in the order message, the inventory data ledger module receives a canceling message of a redeeming bonus points sent by the comparison module, and the record of the deduction of bonus points in the inventory data ledger module is deleted according to the canceling message of redeeming bonus points wherein the information includes: the model of the target cutting machine, the consumption components of the target cutting machine, and the user device.

11. The cutting machine supplying and marketing method of claim 9, further comprising: making comparisons with the cloud data evaluation module according to a component parameter range, a workpiece parameter range and an operational-status parameter range of the target cutting machine that are respectively corresponding to the basic data of components, workpieces and the operational status of the target cutting machine in order to evaluate the correctness of the basic data, and if the basic data of components, workpieces and the operational status of the target cutting machine do not fall within the component parameter range, the workpiece parameter range and the operational-status parameter range of the target cutting machine respectively, it is determined that the basic data of components, workpieces or the operational status of the target cutting machine is incorrect, and the data that is determined to be incorrect is deleted.

12. The cutting machine supplying and marketing method of claim 9, further comprising: evaluating the availability of the basic data according to the ratio of non-abnormal sensors to the plurality of sensors with the cloud data evaluation module; wherein a plurality of sensors is connected with a plurality of components of the target cutting machine.

13. The cutting machine supplying and marketing method of claim 9, further comprising: the cloud data evaluation module is used to check whether any piece of the basic data of components, workpieces and the operational status of a target cutting machine is blank, so as to evaluate the completeness of the basic data; if any piece of the basic data is blank, it is determined that the basic data is incomplete.

14. The cutting machine supplying and marketing method of claim 9, further comprising:
calculating a reward value or a cash back according to a data volume of the basic data recorded in the cloud data ledger module by the cloud supplying module.

15. The cutting machine supplying and marketing method of claim 9, further comprising:
recording an inventory of the components and updating the inventory of the components according to the transaction record by an inventory data ledger module.

16. The cutting machine supplying and marketing method of claim 9, wherein the step of comparing the basic data with the estimated component mechanical consumption data to generate the comparison result and transmitting the component purchase reminder message to the user device when the comparison result is less than the threshold by the cloud supplying module for the user device to determine whether the order have to be made further comprises:
automatically generating the component purchase reminder message according to the estimated component mechanical consumption data and a purchase condition by the cloud supplying module.

17. The cutting machine supplying and marketing method of claim 9, further comprising:
comparing the basic data of the target cutting machine with basic data of a plurality of default cutting machines stored in a cloud database to calculate an estimated machining parameter comprising an estimated cutting tool mechanical consumption rate obtained from a neural network model by the cloud supplying module;
executing a comparison process to compare the estimated cutting tool mechanical consumption rate with an actual mechanical consumption rate, of the target cutting machine implementing a machining process, and generating a suggested machining parameter by the cloud supplying module; and
executing the machining process by the target cutting machine according to the suggested machining parameter.
